(19) United States
(12) Patent Application Publication
(10) Pub. No.: US 2010/0115528 A1
(43) Pub. Date: May 6, 2010

(54) Software Defined Radio

(75) Inventors: Antti-Veikko Sakari Piipponen, Tampere (FI); Kalle August Raiskila, Nurmijarui (FI); Tommi Juhani Zetterman, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/609,261

(22) Filed: Oct. 30, 2009

Related U.S. Application Data
(60) Provisional application No. 61/197,882, filed on Oct. 30, 2008.

(51) Int. Cl. G06F 9/46; H04B 1/40; G06F 9/00

(52) U.S. Cl. 718/104; 455/73; 713/100

(57) ABSTRACT

A method for providing a division of SDR RA into operational states is described. The method includes, in a device which including a plurality of shared device resources and a plurality of RAs, receiving, from a first RA, a request to change a state of the first RA to a requested active state. The requested active state is one of a plurality of potential active states for the first RA and each potential active state has an associated set of device resource requirements. The method also includes determining whether sufficient device resources exist for the requested active state based at least in part on currently allocated device resources. In response to a determination that sufficient device resources exist, the change to the requested active state for the first RA is approved. Apparatus and computer readable media are also described.

### RELATED APPLICATION

This application claims priority to U.S. Provisional Patent Application No. 61/197,882, filed Oct. 30, 2008, which is hereby incorporated by reference in its entirety.

### TECHNICAL FIELD

The non-limiting example embodiments of this invention relate generally to wireless communication systems, methods, devices and computer programs and, more specifically, relate to division of software defined radio applications into operational states.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

BB baseband

CPU central processing unit

FEM front-end modules

GSM global system for mobile communications

HW hardware

IF interface

MRC multiradio controller

OS operating system

RA radio application

RF radio frequency

RM resource manager

RSS received signal strength

RT real-time

SDR software defined radio

SW software

URSI unified radio system interface

WCDMA wideband code division multiple access

WLAN wireless local access network

Designing software defined radios (SDR) for handheld multimedia devices has become a major challenge in bringing mobile internet services to consumer markets. The emerging need for high data rate wireless services and the ever-growing number of wireless standards leads to an urgent demand for an SDR architecture that is optimized for multiradio control and run-time resource management.

Major issues are related not only to new technology driven radio access methods but also to the coexistence with earlier standards having a solid global installation base, for example, GSM, WCDMA and WLAN. The optimized radio access for each application strongly depends on technology parameters and market situations. This has led to an ever growing number of radio standards embedded in consumer devices such as multimedia computers, internet tablets, enterprise products and mobile phones.

Like a conventional computer, a radio computer has to be able to execute multiple concurrent applications each with their own resource demands. The radio spectrum may be one of the more critical resources which active radio applications need to access. However, the radio spectrum may suffer from interoperability problems. Typical sources of interoperability problems include: 1) wide band noise from frequency synthesizers and/or power amplifiers, 2) harmonics, 3) intermodulation of two or more transmitters, 4) RF blocking (desensitization) and 5) clock leakage.

Traditional radio implementations may use statically allocated resources (even dedicated resources) to guarantee proper operation. Many radio applications may be developed assuming the use of a dedicated share of the shared resources (for example, memory, CPU cycles, etc.). When a radio application is brought into execution, resources are guaranteed for its whole active life-cycle, until the application is removed from execution (e.g. when shut down).

A dynamic resource manager may provide resource allocations and de-allocations when radio applications are loaded and unloaded to/from the program execution framework. If resources are guaranteed for the running applications, loading of a new application might fail due to a lack of resources. Otherwise radio applications, not knowing the resource situation, could run into unexpected problems when their resources are unavailable or taken by other radio applications.

Alternatively, the guaranteed resource requirements of a radio application may be based on a “worst-case” situation in order to insure the applications do not exceed their allocated share, leading to catastrophic results. Using ‘worst-case’ situations for a radio application will likely lead to wasted resources as the radio application likely does not use all the allocated resources all of the time.

### SUMMARY

The below summary section is intended to be merely exemplary and non-limiting.

The foregoing and other problems are overcome, and other advantages are realized, by the use of various exemplary embodiments of this invention.

In a first aspect thereof various exemplary embodiments of this invention provide a method for providing a division of SDR RA into operational states. The method includes in a device including a plurality of shared device resources and a plurality of RAs, receiving, from a first RA, a request to change a state of the first RA to a requested active state. The requested active state is one of a plurality of potential active states for the first RA and each potential active state has an associated set of device resource requirements. The method also includes determining whether sufficient device resources exist for the requested active state based at least in part on currently allocated device resources. In response to a determination that sufficient device resources exist, the change to the requested active state for the first RA is approved.

In another aspect thereof various exemplary embodiments of this invention provide an apparatus for providing a division of SDR radio application into operational states. The apparatus includes one or more processor and one or more memory which includes computer program code. The one or more memory and the computer program code configured to, with the one or more processor, cause the apparatus to perform operations. The operations include to receive, from a first RA, a request to change a state of the first RA to a requested active state, where the requested active state is one of a plurality of potential active states for the first RA and where each potential active state has an associated set of device resource requirements; to determine whether sufficient device resources exist for the requested active state based at least in part on currently allocated device resources; and in response to a determination that sufficient device resources exist, to approve the change to the requested active state for the first RA.

In a further aspect thereof various exemplary embodiments of this invention provide a computer readable medium tangibly encoding a computer program comprising program instructions, execution of the program instructions resulting in operations for providing a division of SDR radio application into operational states. The operations include, in a device including a plurality of shared device resources and a plurality of RAs, receiving, from a first RA, a request to change a state of the first RA to a requested active state. The requested active state is one of a plurality of potential active states for the first RA and each potential active state has an associated set of device resource requirements. The operations also include determining whether sufficient device resources exist for the requested active state based at least in part on currently allocated device resources. In response to a determination that sufficient device resources exist, the change to the requested active state for the first RA is approved.

In another aspect thereof various exemplary embodiments of this invention provide an apparatus for providing a division of SDR radio application into operational states. The apparatus includes a plurality of shared device resources; a plurality of RAs; means for receiving, from a first RA, a request to change a state of the first RA to a requested active state, where the requested active state is one of a plurality of potential active states for the first RA and where each potential active state has an associated set of device resource requirements; means for determining whether sufficient device resources exist for the requested active state based at least in part on currently allocated device resources; and means for, in response to a determination that sufficient device resources exist, approving the change to the requested active state for the first RA.

### BRIEF DESCRIPTION OF THE DRAWINGS

In the attached Drawing Figures:

FIG. 1 depicts an exemplary SDR functional architecture.

FIG. 2 shows a simplified example block diagram of the timing concept in resource scheduling.

FIG. 3 illustrates a simplified example diagram of a multiradio scheduling timeline.

FIG. 4 illustrates a simplified block diagram of an exemplary radio computer platform.

FIG. 5 shows a simplified block diagram of an exemplary radio system resource usage.

FIG. 6 depicts a simplified block diagram of an exemplary radio system operation state change.

FIG. 7 depicts a simplified example chart of checks to be performed at each state change.

FIG. 8 shows a simplified block diagram of a user equipment that is suitable for use in practicing the exemplary embodiments of this invention.

FIG. 9 is a logic flow diagram that illustrates the operation of a method, and a result of execution of computer program instructions embodied on a computer readable memory, in accordance with the exemplary embodiments of this invention.

FIG. 10 is another logic flow diagram that illustrates the operation of another method, and a result of execution of another computer program instructions embodied on a computer readable memory, also in accordance with the exemplary embodiments of this invention.

FIG. 11 is another logic flow diagram that illustrates the operation of a method of operation for a radio application, and a result of execution of a computer program instructions embodied on a computer readable memory, also in accordance with the exemplary embodiments of this invention.

### DETAILED DESCRIPTION

As described above, in a static resource allocation scheme, when a radio application is brought into execution, resources are guaranteed for its whole active life-cycle, until the application is removed from execution. Various exemplary embodiments in accordance with this invention provide for a division of software defined radio applications into operational states. The overall resource utilization rate when sharing platform resources is optimized, as each operational state only reserves the resources to perform the predefined functions in that specific state. Re-allocation may happen more often, for example, each time an application changes its state. Thus, providing an ability to use more fine-grained operational states during various stages in the active life-cycle of the radio application.

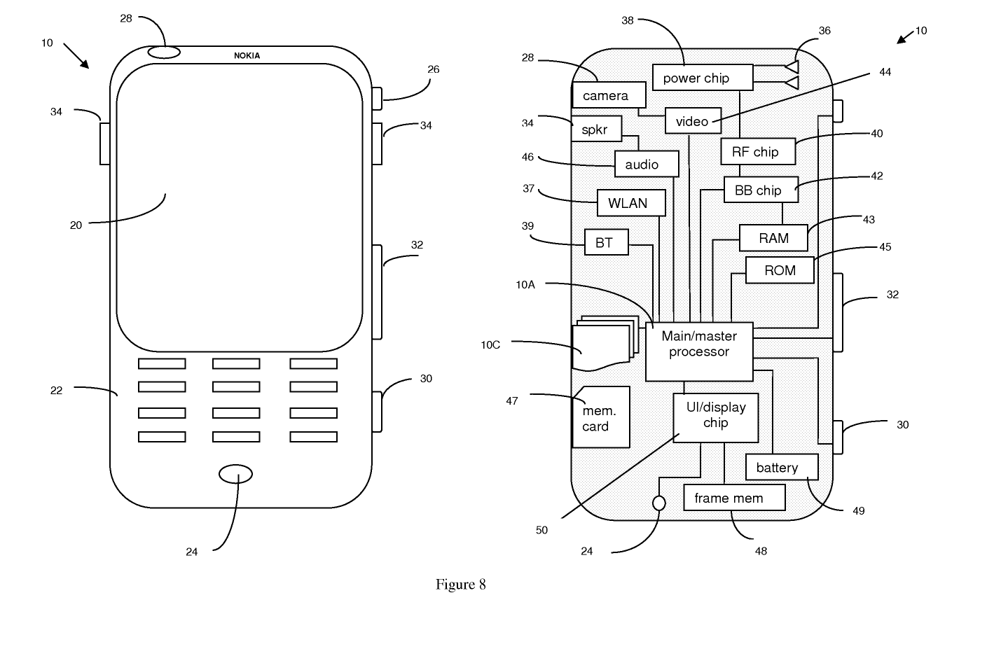

FIG. 8 illustrates an exemplary apparatus, such as a mobile communication device which may be referred to as a UE 10, in both plan view (left) and sectional view (right), and the invention may be embodied in one or some combination of those more function-specific components.

The UE 10 is adapted for communication over a wireless link. The UE 10 includes a controller, such as a computer or a data processor (DP) 10A, a computer-readable memory medium embodied as a memory (MEM) that stores a program of computer instructions (PROG) 10C, and a suitable radio frequency (RF) transceiver (or similar technology, e.g., transmit/receive antennas 36) for bidirectional wireless communications with the eNB via one or more antennas.

The PROGs 10C is assumed to include program instructions that, when executed by the associated DP, enable the device to operate in accordance with exemplary embodiments of this invention, as will be discussed below in greater detail.

That is, exemplary embodiments of this invention may be implemented at least in part by computer software executable by the DP 10A of the UE 10, or by hardware, or by a combination of software and hardware (and firmware).

In general, various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A may be of any type suitable to the local technical environment, and may include one or more of general purpose computers, special purpose computers, microprocessors, digital signal processors (DSPs) and processors based on a multicore processor architecture, as non-limiting examples.

At FIG. 8 the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 9 are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22, microphone 24, and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47. The various programs 10C are stored in one or more of these memories. All of these components within the UE 10 are normally powered by a portable power supply such as a battery 49.

Processors 38, 40, 42, 44, 46, 50, if embodied as separate entities in a UE 10, may operate in a slave relationship to the main processor 10A, which may then be in a master relationship to them. Any or all of these various processors of FIG. 9 access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node, which may have an array of tower-mounted antennas rather than the two shown at FIG. 9.

Note that the various chips (e.g., 38, 40, 42, etc.) that were described above may be combined into a fewer number than described and, in a most compact case, may all be embodied physically within a single chip.

A radio application, which runs on an SDR platform with shared resources, may be divided into operational states. In each operational state, only a sub-set of radio functionality may be allowed. The platform resource requirements may be optimized for each type of operational state, so that in general, fewer resources are used per active radio application (for example, compared to a “worst-case” resource requirement situation). If functionality outside the granted operational states is desired, the radio application should first request permission to enter a new operational state. This operational state based resource requirement scheme allows for systematic and consistent improvement of shared resource utilization.

A multiradio computer driven approach to software radio design is described. An exemplary model for a unified radio system is presented as a non-limiting example of a way to bring different radio applications under a common multiradio resource management scheme. A multiradio operating system (OS) may guarantee that simultaneously executing radios applications can meet their real-time behavior requirements while sharing the computing, communication and hardware resources of the radio computer.

To satisfy a need for SDR optimized multiradio control and run-time resource management, an exemplary architecture for a multitasking radio computer is presented. Together with the radio OS, which provides multiradio resource management, multiple individual radio applications can be executed simultaneously on top of shared computing, communication and hardware resources. The behavior of radio applications is strictly regulated by their frequency and time domain behaviors.

All functionalities of a multiradio computer may be specified in a model-driven and service-oriented manner with well defined interfaces between all service and system components. This exemplary architecture may then be further decomposed in order to separate SDR control functions from the set of radio system applications. These SDR control functions, which are common to radio applications, may be provided at a universal radio system interface. This interface subjects the radio applications to a common multiradio resource management framework.

This exemplary architecture and the related resource model may be platform neutral in that they allow widely different implementation choices. In an exemplary embodiment in accordance with this invention, a heterogeneous multiprocessor platform supports the multiradio resource management framework and allows for fine-grained resource sharing, while allowing each radio application to be designed according to a common paradigm and executed in virtual isolation from other radio applications.

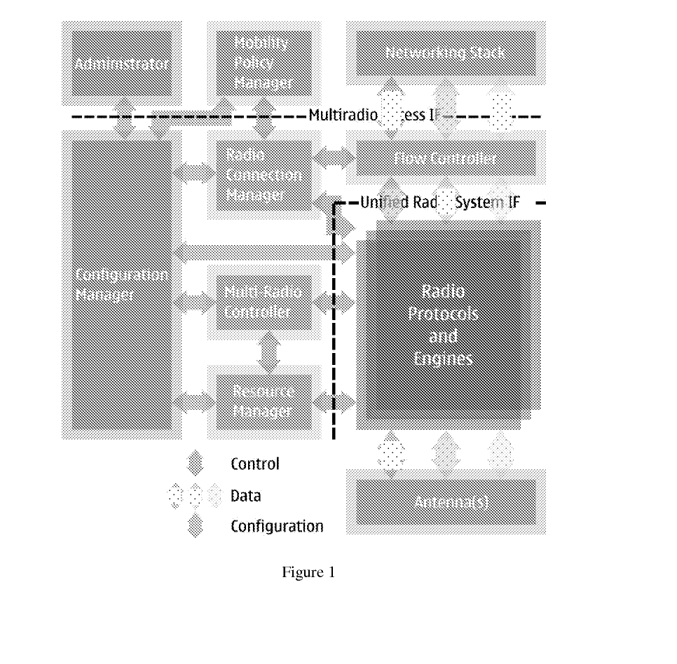

FIG. 1 depicts an exemplary SDR functional architecture of a radio computer device. Services of the radio computer are provided at the multiradio access interface (IF). The services may include connectivity and data transfer, but also positioning and broadcasting services. User applications may access the radio computer via a networking stack and mobility policy manager, which maintains user preference policies for selecting radio applications. Additional services for installing new radio applications into radio computer are available.

The multiradio access interface may be supported by a common SDR control framework, which consists of the configuration manager, radio connection manager, flow controller, multiradio controller and resource manager system components. Their functionalities are useful for most radio systems and may be part of the radio OS. The SDR control framework is responsible for several operations, included installing, loading and activating different radio applications and maintaining user data flows (which can also be switched from one radio application to another). The radio OS also handles multiradio control and resource management for sharing of available spectrum and radio computer resources among simultaneously executing radio applications.

The services of the SDR control framework are available to the radio systems at the unified radio system interface (URSI). With such an interface each application can be integrated into the radio computer in a unified manner by making them subject to a common multiradio resource management.

The URSI can be referenced, when checking the compatibility of individually developed radio system software implementations. It can also be used as a harmonization interface for adapting future radio systems into the SDR functional architecture.

An exemplary SDR control framework allows activating and removing radio applications during run-time. A set of radio applications may be pre-installed into the radio computer, and new ones may be brought in by using the administrator services of the multiradio access interface.

The life cycle of a radio application inside the radio computer may be described by using four distinct administrative states, which differ by their use of the shared platform resources: 1) a “not installed” radio application is unknown by the radio computer; 2) an “installed” radio application is an application for which the radio computer has a copy of the radio system package (including resource budgets and executables)—it may be stored in mass storage in compressed format for minimal memory footprint; 3) a “loaded” radio application is available for the end user, but is not yet in execution; and 4) an “active” state application is an instance of the radio application that is in execution which various hardware codecs and radio frequency circuitry in addition to the computation, memory and communication resources.

Operational states may be defined as sub-states of the “active” state, and are used to describe different resource requirements.

The applications may be divided into various operational states, in order to facilitate more efficient resource sharing. Inside an operational state, the radio application is allowed to operate freely within the given limits of that operational state. Permission to transitions between operational states is requested from the resource manager, which is part of the SDR control framework. Real-time guarantees do not need to be given in order to serve these requests. The radio system may grant or deny transition requests due to resource limitations. In cases where the transition request is denied, the application may propagate information regarding the denial to the multiradio access interface so that the higher-level control elements can take necessary actions to free resources (e.g., deactivate lower priority radio applications, forcing a lower priority radio application into a new operational state, retry the operation state change to a state with lower requirements, make additional resources available and retry the operational state change, report the failure to a device user or to the application using the radio, etc.). The SDR control framework may guarantee resources for the granted operational states.

An exemplary platform neutral SDR functionalal architecture may decompose the unified radio system into two parts, (radio) protocols and (radio) engines (e.g., resources). The protocols part controls the time behavior of the radio system, and the engines part performs the radio communication operations at specific times and with specific configurations.

The protocols part may take care of interaction with the user and the external communication partners. It is aware of the current operational state and detects when there is a need to transition to another state, for example, when there is a change in the resource demands. When the protocols part detects the need to transition to another operational state it may request authorization for the transition. The engines part may implement the signal processing and radio frequency functions (as instructed by the protocols part) and contains an accurate time for the radio system.

This split between protocols and engines need not be according to the OSI data link layer and physical layer, real-time properties, or according to platform components. This split may be purely functional and allows the unified interface to be used for many different radio systems. Other division criteria could lead to non-uniform interface description because radio systems differ in the OSI layer radio functionality distribution and real-time properties.

The URSI can harmonize the accessing of dissimilar radio applications, as well as their behavior on the SDR platform. To aid in this, radio applications may provide a set of services as specified in the URSI, to be compatible with the SDR functional architecture. Access to the shared platform resources and the radio spectrum is received by using the SDR control framework services.

The services provided by unified radio systems may cover a range of different services, for example, services related to activation and deactivation of applications, neighbor device discovery, and establishing communication and user data flows. The SDR control framework services may be used by the radio applications to set up baseband signal processing and radio frequency resources, and subsequently to access the radio spectrum.

The typical way to solve interoperability problems is to forbid one or more of the simultaneously active radio applications from operating. Such a decision may, for example, be based on the different priorities associated to the radio applications.

The SDR functional architecture may contain a specific functional block (or entity) to dynamically schedule access to spectral resources, e.g., a multiradio controller (MRC). A responsibility of the scheduler is to detect, in advance, interoperability problem between simultaneously active radio applications and to resolve such problems. Radio applications may connect to the scheduler via the URSI, which makes it possible to add new radio applications to the multiradio control scheme.

To enable the exemplary scheduler, radio applications executed in the SDR platform may have two additional functions: 1) a function to tell the scheduler, in advance, of temporal requirements and parameters for transmission and reception and 2) a function to provide internal time and synchronization information to the MRC. Additionally, the radio application can utilize scheduling results, for example, to prepare retransmission when a scheduler denies operation or to go into a sleep mode at the end of a granted radio access.

The operational states may contain information about the resources used to perform the specific functionality allowed in the state. It's the responsibility of resource management to determine whether these resources are available.

FIG. 3 illustrates a simplified diagram of a multiradio scheduling timeline. Scheduling window, t_{w}, defines the window of time for scheduling requests to be solved during one scheduling round. Time t1 defines the deadline for when the scheduler receives information about the behavior of radio applications to be able to calculate a schedule during that scheduling round. By time t2, scheduling decisions are communicated back to radio applications in order to have sufficient time to configure the radio HW and/or SW for operation. Time t3 defines when radio HW and SW should be configured and ready for operation. T3 may be earlier than the actual starting time of the radio operation.

The values for these time parameter may be defined depending on the performance of the SDR platform and the ability of the radio applications to accurately estimate their schedule in advance.

An exemplary scheduler may provide scheduling services for radio applications via the URSI. The scheduling service may be used for three different types of requests 1) a rigid request, 2) a continuous request and 3) a flexible request. A rigid request is used when a single radio operation has fixed start and end times. The requested time slot is either accepted as a whole, or rejected. Since the request needs to be solved during one scheduling round, the rigid request may not be longer than t_{w}. A continuous request is used when a single radio operation takes longer than t_{w}. A continuous request may be scheduled in multiple parts and communicated to the radio applications one part at a time. Alternatively, the schedule may be communicated using a semi-persistent scheduling scheme. Flexible requests are used when the scheduler is allowed to select one of multiple alternatives or to modify the timing of radio operation in case of a resource conflict. For example, the scheduler may either advance or delay the granted time slot.

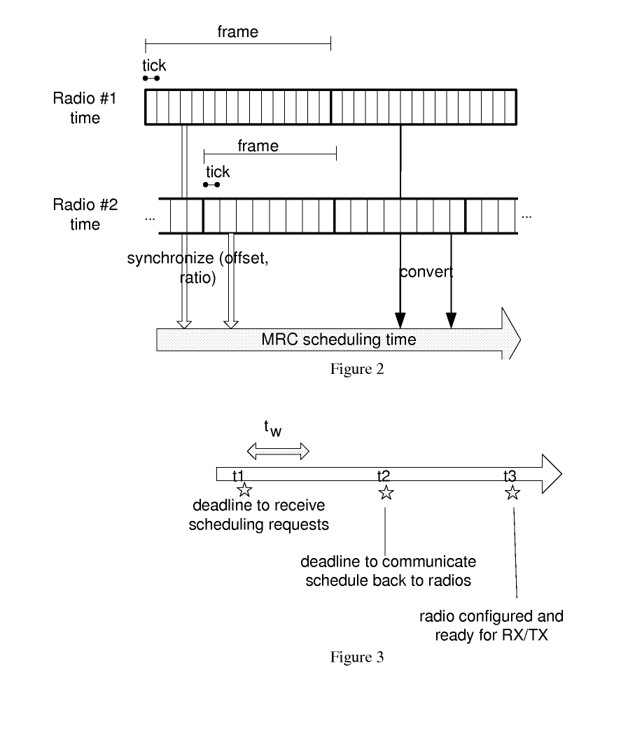

FIG. 2 shows a simplified example block diagram of the timing concept in resource scheduling.

To be able to accurately detect and solve interoperability problems, the scheduler should know the characteristics of the requested radio operations. Besides timing parameters, other parameters can be specified for each scheduling request, for example, the priority of the request, the requested transmitter power, receiver signal quality information (e.g., RSS), the requested channel bandwidth, the carrier frequency and a crest factor.

Radio applications may be real-time (RT) applications. The validity of the computational results may depend on both values and on the time at which the values are produced. The RT behavior of an application may be dependent on the amount of resources available to it during execution. Uncertainty in resource provisions may cause unpredictable temporal behavior.

In a multiradio system, many radio applications may be active at the same time. Furthermore, each radio application can be in one of several different operational states. Each operational state describes different resource requirements.

In order to allow increased flexibility at reduced resource costs, radio applications may share computation, memory and communication resources, as well as hardware resources such as RF transceivers and antennas. The ability to satisfy temporal constraints may depend on resource availability. Resource sharing can make the temporal behavior of each radio depend on the behavior of all other radio applications in the system, which is difficult to predict where radio combinations are dynamic.

Each radio application may be implemented in such a way that it only uses a fraction of the platform resources. A resource budget is associated with each operational state of a radio application. The resource budget indicates all resources of the platform that the radio application will require to meet the RT requirements.

An exemplary resource management policy may ensure admission controls such that a radio application is allowed to change operational states if the system can 1) allocate resources sufficient for the resource budget required for that operational state; and 2) guarantee the resource provisions such that access to the allocated resources cannot be denied to the radio application.

A change of operational states may be rejected if there is a lack of resources on the platform. Thus, RT guarantees may not always be provided during operational state changes.

Different components of a radio application may have different RT requirements. Baseband (BB) and RF applications may have hard RT requirements, as a failure in meeting deadlines may cause the output to be worthless (e.g. decoding a WLAN packet should be done within the deadline), while the higher level control protocols may be laxer in meeting RT constraints.

Resource management functionality in an exemplary SDR radio computer platform may be distributed in a hierarchical manner. A central resource manager may handle operational state change requests. The central resource manager may oversee platform component resource managers, each of which provides admission control and resource reservation services for an associated platform component.

Resources may be reserved and configured. An admission check may be done, without reservation, for each of the platform component resource managers. The platform component resource managers may retrieve the operational state specific resource budgets from the radio system description package. Once admission has been granted on the platform components, the central resource manager may proceed with resource reservations. Resource reservations may include configuration of the resources. Local dynamic loaders may be instructed to request executables from the radio system package in a central repository and store the executables in a specific memory location.

In the central resource manager, the operational state change requests for the different radio applications may be queued. The admission check and resource reservation with configuration may constitute a single atomic operation.

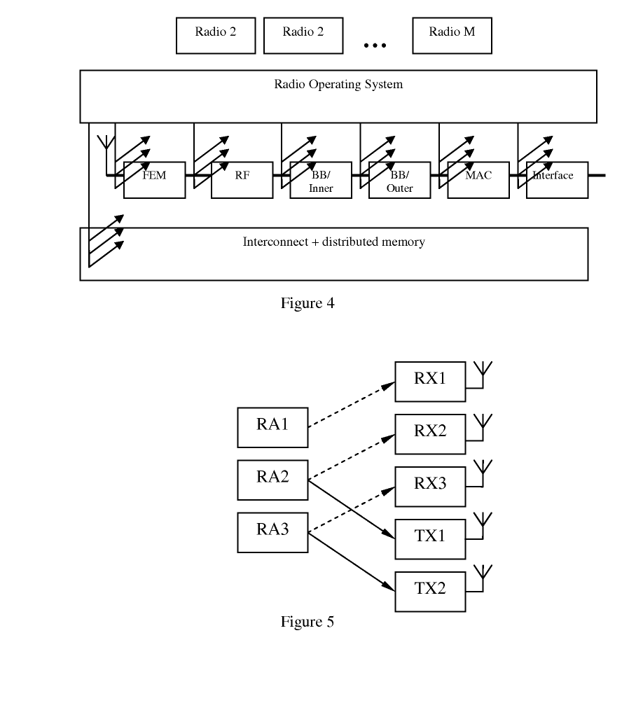

FIG. 4 illustrates a simplified block diagram of an exemplary radio computer platform. The radio computer platform may be conceptualized as a plurality of stages, covering both receive and transmit functions. These stages include one or more antennas, front-end modules (FEM) (for example, filters, power amps, etc); RF transceivers; baseband processors for (de)modulation; baseband processors for (de-)coding; control processors for protocol stacks; and/or application interface units.

In active communications, signals are transmitted back and forth with a communication peer. In power save, a mobile handset receives a signal from the peer every now and then (which may be used to indicate a desire for active communication, e.g. a network informs the mobile handset that a phone call is inbound). As required, the mobile handset may transition into an active communication mode.

The active mode may use both receiver and transmitter resources. The power save mode uses receiver resources (since it listens for a signal from the peer) thereby leaving the transmitter resources for use by other concurrently active radio applications. An executable program in power save mode may also take less space in processors' memories, and utilize less communication bus bandwidth. Additionally, power save mode consumes less power than active mode since it is not transmitting. Therefore, the platform resources can be as fine-grained as what can be reasonably measured and allocated.

Each operational state may correspond to a resource budget, that is its “worst-case” usage. The more fine-grained the operational states, the better resource utilization can be achieved. Thus, resource allocation can be used based on a per operational state budget rather than an overall “worst-case” situation. Resources sufficient for the currently active operational state for each radio application may be guaranteed.

Radio applications should be able to cope with a possible rejection of transition request. This may be done by escalating the failure indication up to a mobility policy manager. The mobility policy manager may know which radio applications and connections are priorities at any given time.

Additionally, the request to transition into a new operational state may take time to process, as might the resource setup after admission of the new operational state. The transition time provides an opportunity to unload program code for the old operational state and to load new code for the new operational state, if the execution memory is scarce compared to storage, or if the radio applications are stored in compressed form (so that the program code of the current operational state is extracted into execution memory).

However, functions that might benefit from a quick reaction time may be grouped into specific operational states as the transition from one operational state to another may take additional time. These operational states may provide for resources sufficient to handle the resource demands instead of waiting for a new operational state.

The designation of an operational state may be based the percentage of RF resources used, the percentage of BB resources used, duty cycles and/or activity interval (μs/ms). For an exemplary SDR architecture model in accordance with this invention, the operations state may include the following exemplary states:

Idle—where the radio application is not doing anything, uses no resources apart from memory.

Scanning—where the radio application is actively looking for potential communication partners.

Camping—where the radio application is associated to a network/peer, only receiving controlling channel traffic.

Communicating—where the radio application is exchanging data with a network/peer.

The allocation of resources may be based on a balancing of system resources demands.

To perform operations, radio applications may use different types of resources, for example, a micro processor unit (MPU) to run SW algorithms, a baseband unit (BB) to perform baseband computation, and a radio frequency unit (RF) to perform RF signal processing as well as to send and to receive RF messages. The resource classifications (MPU, BB, RF) are used here as non-limiting examples as other classifications are also possible.

FIG. 5 shows a simplified block diagram of an exemplary radio system resource usage. A first radio application (RA1) may be in a camping operational state that uses only a radio receiver (RX1). A second radio application (RA2) may be in a first communication operating state and uses a second radio receiver (RX2) and a radio transmitter (TX1). A third radio application (RA3) may be in a second communication operating state that uses a third radio receiver (RX3) and a second radio transmitter (TX2).

The exemplary radio systems may also require MPU and BBU resources. In this simplified example these computing resources may be expressed as percentages of total CPU capacity of the unit used. The exemplary radios may require the following resources:

| Radio | MPU capacity | BBU capacity |
|---|---|---|
| RA1 | 65% of CPU capacity | 20% of CPU capacity |
| RA2 | 50% of CPU capacity | 35% of CPU capacity |
| RA3 | 40% of CPU capacity | 40% of CPU capacity |

Based on the currently active operational states, different kinds of resources may be allocated to the radio applications. RA1 and RA2 can share a common resource (e.g., BBU1), counting a total resource usage of 55% for that resource. RA3 may be allocated its own resources, with 40% utilization (e.g., BBU2).

An alternative resource allocation to that shown in FIG. 5, is to allocate the three radio applications to a single BBU, such that the BBU has a 95% utilization and then powering down a second baseband. This alternative allocation may thus lead to an energy savings.

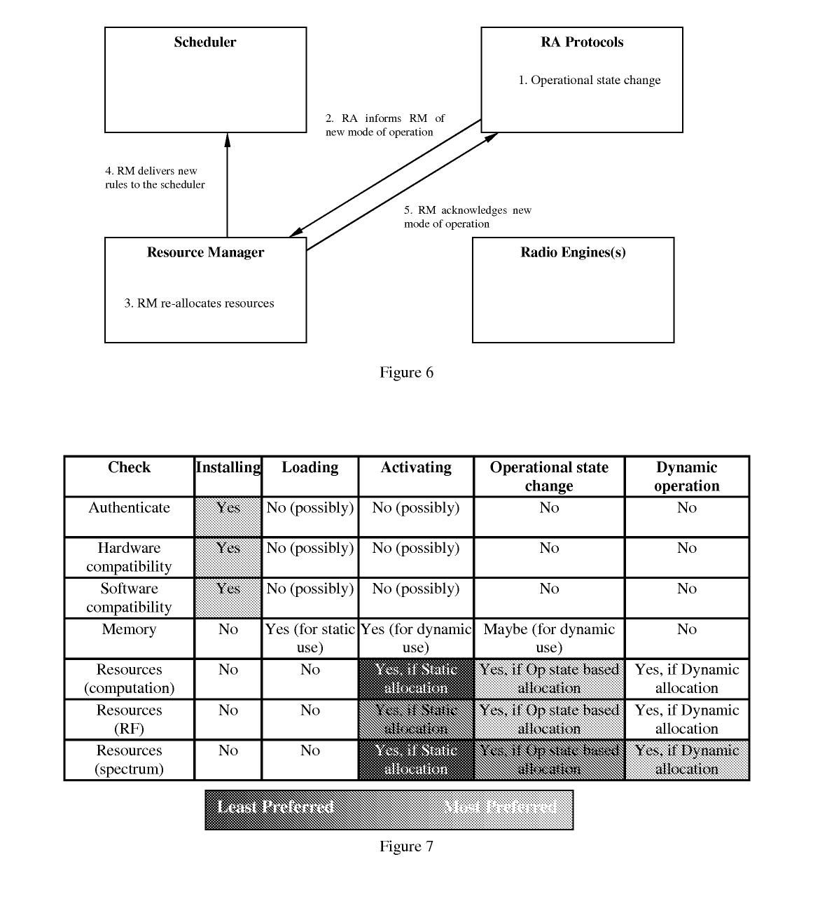

FIG. 6 depicts a simplified block diagram of an exemplary radio system operational state change. At step 1, the radio application (RA) formulates an operational state change request. The RA informs the resource manager (RM) of the requested mode of operation (for example, the requested operational state) at step 2. At step 3, the RM re-allocates resources according to the request. The RM delivers new rules to a scheduler (e.g., a multiradio controller (MRC)) according to the re-allocated resources, at step 4. At step 5, the RM acknowledges the new mode of operation (for example, the requested operation state) to the RA.

FIG. 7 depicts a simplified chart of exemplary checks that may be performed at a state change. For example, when a radio application requests an ‘installing’ state, the resource manager may authenticate the radio application and verify both HW and SW compatibility. However, the resource manager does not need to check memory resources, computational resource, RF resource or spectrum resources as an application in the ‘installing’ state may not need access to those resources.

Additionally, the radio application may then request a transition from the ‘installing’ state to a ‘loading’ state. In this case, the resource manager may check that sufficient memory is available. The resource manager does not need to perform the other checks at this time.

Based on the foregoing it should be apparent that the exemplary embodiments of this invention provide a method, apparatus and computer program(s) to provide a division of SDR radio application into operational states.

FIG. 8 is a logic flow diagram that illustrates the operation of a method, and a result of execution of computer program instructions, in accordance with the exemplary embodiments of this invention. In accordance with these exemplary embodiments of the method, at Block 1010, an indication of an operational state (which identifies radio resource requirements) is received from radio applications (one or more radio applications may be in operation). Resources are allocated to the radio application(s) based at least in part on the (individual) operational state(s) of the radio application(s) at block 1020. At block 1030, indication(s) of the allocated resources are sent to the radio application(s).

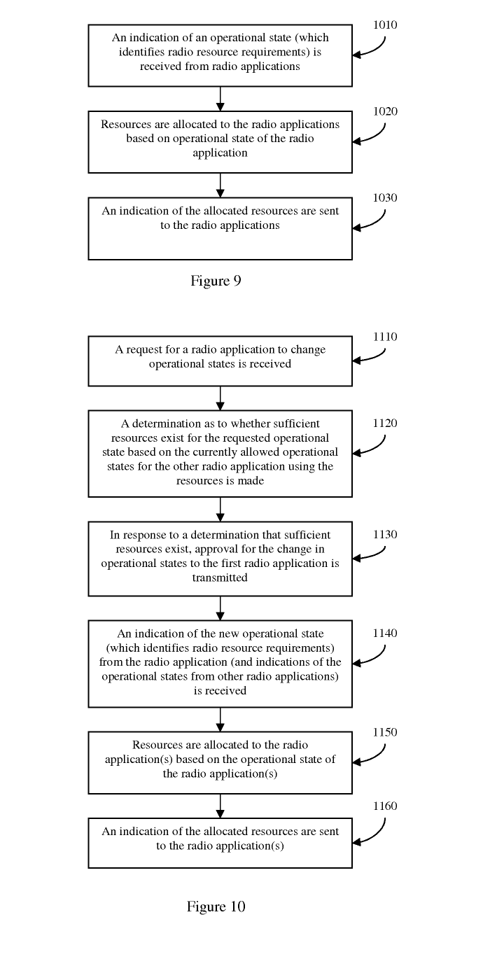

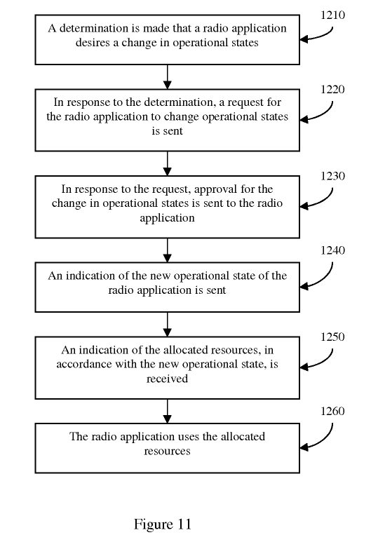

FIG. 10 is another logic flow diagram that illustrates the operation of another method, and a result of execution of another computer program instructions embodied on a computer readable memory, also in accordance with the exemplary embodiments of this invention. In accordance with these exemplary embodiments of this method, at Block 1110, a request for a radio application to change operational states is received. A determination as to whether sufficient resources exist for the requested operational state based at least in part on the currently allowed operational states for the other radio application using the resources (if any) is made at Block 1120. At block 1130, in response to a determination that sufficient resources exist, approval for the change in operational states to the first radio application is transmitted. An indication of the new operational state (which identifies radio resource requirements) from the radio application (and indications of the operational states from other radio applications) is received at Block 1140. At block 1150, resources are allocated to the radio application(s) based at least in part on the operational state of the radio application(s). An indication of the allocated resources are sent to the radio application(s), at Block 1160.

FIG. 11 is another logic flow diagram that illustrates the operation of a method of operation for a radio application, and a result of execution of a computer program instructions embodied on a computer readable memory, also in accordance with the exemplary embodiments of this invention. In accordance with these exemplary embodiments of this method, at Block 1210, a determination is made that a radio application desires a change in operational states. In response to the determination, a request for the radio application to change operational states is sent at Block 1220. At block 1230, in response to the request, approval for the change in operational states is sent to the radio application. An indication of the new operational state of the radio application is sent at Block 1240. At block 1250, an indication of the allocated resources, in accordance with the new operational state, is received. The radio application uses the allocated resources, at Block 1260.

The various blocks shown in FIGS. 9, 10 and 11 may be viewed as method steps, and/or as operations that result from operation of computer program code, and/or as a plurality of coupled logic circuit elements constructed to carry out the associated function(s).

An exemplary embodiment in accordance with this invention is a method for providing a division of SDR radio application into operational states. The method includes receiving an indication of an operational state from each of one or more of radio applications, where the operational state includes an identification of radio resource requirements. Resources for the radio application(s) are allocated based at least in part on the indication(s) of the operational states. Sending an identification of allocated resources to the one or more radio applications is also included.

In a further exemplary embodiment of the method above, the method also includes receiving a request for a change in operational states from a first radio application. A determination is made as to whether sufficient resources exist for the requested operational state based at least in part on currently allowed operational states for each radio application using the resources. The method includes transmitting approval for the change in operational states to the first radio application if sufficient resources exist.

In another exemplary embodiment of the method above, the method includes transmitting a denial for the change in operational states to the first radio application in if sufficient resources do not exist.

In a further exemplary embodiment of any one of the methods above, the request further includes an indication of a priority of the radio application. Determining whether sufficient resources exist may be further based on the priority of each radio application using the resources.

In another exemplary embodiment of any one of the methods above, the method includes if sufficient resources do not exist determining whether a second radio application using the resources has a lower priority than the first radio application and if the second radio application has a lower priority, transmitting instructions to change operational states to the second radio application, and transmitting approval for the change in operational states to the first radio application.

In a further exemplary embodiment of any one of the methods above, an operational state corresponds to a set of maximum allowed resource usage.

In another exemplary embodiment of any one of the methods above, the operational state further includes an identification of one or more of memory resource requirements and processor resource requirements.

An exemplary embodiment in accordance with this invention is an apparatus for providing a division of SDR radio application into operational states. The apparatus includes one or more processor and one or more memory which includes computer program code. The one or more memory and the computer program code configured to, with the one or more processor, cause the apparatus to perform operations. The operations include receiving an indication of an operational state from each of one or more of radio applications, where the operational state includes an identification of radio resource requirements. Resources for the radio application(s) are allocated based at least in part on the indication(s) of the operational states. Sending an identification of allocated resources to the one or more radio applications is also included.

In a further exemplary embodiment of the apparatus above, the operations also include receiving a request for a change in operational states from a first radio application. A determination is made as to whether sufficient resources exist for the requested operational state based at least in part on currently allowed operational states for each radio application using the resources. The operations include transmitting approval for the change in operational states to the first radio application if sufficient resources exist.

In another exemplary embodiment of the apparatus above, the operations include transmitting a denial for the change in operational states to the first radio application in if sufficient resources do not exist.

In a further exemplary embodiment of any one of the apparatus above, the request further includes an indication of a priority of the radio application. Determining whether sufficient resources exist may be further based on the priority of each radio application using the resources.

In another exemplary embodiment of any one of the apparatus above, the operations include if sufficient resources do not exist determining whether a second radio application using the resources has a lower priority than the first radio application and if the second radio application has a lower priority, transmitting instructions to change operational states to the second radio application, and transmitting approval for the change in operational states to the first radio application.

In a further exemplary embodiment of any one of the apparatus above, an operational state corresponds to a set of maximum allowed resource usage.

In another exemplary embodiment of any one of the apparatus above, the operational state further includes an identification of one or more of memory resource requirements and processor resource requirements.

An exemplary embodiment in accordance with this invention is a computer readable medium tangibly encoding a computer program comprising program instructions, execution of the program instructions resulting in operations for providing a division of SDR radio application into operational states. The operations include receiving an indication of an operational state from each of one or more of radio applications, where the operational state includes an identification of radio resource requirements. Resources for the radio application(s) are allocated based at least in part on the indication(s) of the operational states. Sending an identification of allocated resources to the one or more radio applications is also included.

In a further exemplary embodiment of the computer readable medium above, the operations also include receiving a request for a change in operational states from a first radio application. A determination is made as to whether sufficient resources exist for the requested operational state based at least in part on currently allowed operational states for each radio application using the resources. The operations include transmitting approval for the change in operational states to the first radio application if sufficient resources exist.

In another exemplary embodiment of the computer readable medium above, the operations include transmitting a denial for the change in operational states to the first radio application in if sufficient resources do not exist.

In a further exemplary embodiment of any one of the computer readable medium above, the request further includes an indication of a priority of the radio application. Determining whether sufficient resources exist may be further based on the priority of each radio application using the resources.

In another exemplary embodiment of any one of the computer readable medium above, the operations include if sufficient resources do not exist determining whether a second radio application using the resources has a lower priority than the first radio application and if the second radio application has a lower priority, transmitting instructions to change operational states to the second radio application, and transmitting approval for the change in operational states to the first radio application.

In a further exemplary embodiment of any one of the computer readable medium above, an operational state corresponds to a set of maximum allowed resource usage.

In another exemplary embodiment of any one of the computer readable medium above, the operational state further includes an identification of one or more of memory resource requirements and processor resource requirements.

An exemplary embodiment in accordance with this invention is an apparatus for providing a division of SDR radio application into operational states. The apparatus includes a receiver configured to receive an indication of an operational state from individual ones of a at least one of radio applications, where the operational state comprises an identification of radio resource requirements; a processor unit configured to allocate resources to the radio applications based at least in part on the indications of the operational states; and a transmitter configured to send an identification of allocated resources to the at least one of radio applications.

In a further exemplary embodiment of the apparatus above, the receiver is further configured to receive a request for a change in operational states from a first radio application; the processing unit is further configured to determine whether sufficient resources exist for the requested operational state based at least in part on currently allowed operational states for each radio application using the resources; and the transmitter is further configured to send approval for the change in operational states to the first radio application in response to a determination that sufficient resources exist.

In another exemplary embodiment of any one of the apparatus above, the transmitter is further configured to send a denial for the change in operational states to the first radio application in response to a determination that sufficient resources do not exist.

In a further exemplary embodiment of any one of the apparatus above, the request further comprises an indication of a priority of the radio application and determining whether sufficient resources exist is further based on the priority of each radio application using the resources.

In another exemplary embodiment of any one of the apparatus above, the processing unit is further configured to determine whether a second radio application using the resources has a lower priority than the first radio application in response to a determination that sufficient resources do not exist; and the transmitter is further configured to send instructions to change operational states to the second radio application, and approval for the change in operational states to the first radio application in response to determining the second radio application has a lower priority.

In a further exemplary embodiment of any one of the apparatus above, an operational state corresponds to a set of maximum allowed resource usage.

In another exemplary embodiment of any one of the apparatus above, the operational state further includes an identification of one or more of memory resource requirements and processor resource requirements.

An exemplary embodiment in accordance with this invention is an apparatus for providing a division of SDR radio application into operational states. The apparatus includes means for receiving an indication of an operational state from each of one or more of radio applications, where the operational state includes an identification of radio resource requirements. Means for allocating resources for the radio application(s) based at least in part on the indication(s) of the operational states are included. The apparatus also includes means for sending an identification of allocated resources to the one or more radio applications.

In a further exemplary embodiment of the apparatus above, the apparatus also includes means for receiving a request for a change in operational states from a first radio application. Means for determination whether sufficient resources exist for the requested operational state based at least in part on currently allowed operational states for each radio application using the resources are include. The apparatus includes means for transmitting approval for the change in operational states to the first radio application if sufficient resources exist.

In another exemplary embodiment of the apparatus above, the apparatus includes means for transmitting a denial for the change in operational states to the first radio application in if sufficient resources do not exist.

In a further exemplary embodiment of any one of the apparatus above, the request further includes an indication of a priority of the radio application. Determining whether sufficient resources exist may be further based on the priority of each radio application using the resources.

In another exemplary embodiment of any one of the apparatus above, the apparatus includes means for determining whether a second radio application using the resources has a lower priority than the first radio application if sufficient resources do not exist and means for transmitting instructions to change operational states to the second radio application and for transmitting approval for the change in operational states to the first radio application if the second radio application has a lower priority are included.

In a further exemplary embodiment of any one of the apparatus above, an operational state corresponds to a set of maximum allowed resource usage.

In another exemplary embodiment of any one of the apparatus above, the operational state further includes an identification of one or more of memory resource requirements and processor resource requirements.

An exemplary embodiment in accordance with this invention is a method for providing a division of SDR radio application into operational states. The method includes sending an indication of an operational state from a radio application, where the operational state includes an identification of radio resource requirements. In response to sending the indication, receiving an identification of allocated resources is also included. The allocated resources are used by the radio application.

In a further exemplary embodiment of the method above, the method includes determining whether a change in operational states is desired based at least in part on radio resource requirements. The method also includes sending a request for the change in operational states. The method includes receiving approval for the change in operational states to the first radio application if sufficient resources exist.

In another exemplary embodiment of the method above, the method includes receiving a denial for the change in operational states if sufficient resources do not exist.

In a further exemplary embodiment of any one of the methods above, the request further includes an indication of a priority of the radio application.

In another exemplary embodiment of any one of the methods above, the method includes receiving instructions to change operational states.

In a further exemplary embodiment of any one of the methods above, an operational state corresponds to a set of maximum allowed resource usage.

In another exemplary embodiment of any one of the methods above, the operational state further includes an identification of one or more of memory resource requirements and processor resource requirements.

An exemplary embodiment in accordance with this invention is a computer readable medium tangibly encoding a computer program comprising program instructions, execution of the program instructions resulting in operations for providing a division of SDR radio application into operational states. The operations include sending an indication of an operational state from a radio application, where the operational state includes an identification of radio resource requirements. In response to sending the indication, receiving an identification of allocated resources is also included. The allocated resources are used by the radio application.

In a further exemplary embodiment of the computer readable medium above, the operations includes determining whether a change in operational states is desired based at least in part on radio resource requirements. The operations also include sending a request for the change in operational states. The operations include receiving approval for the change in operational states to the first radio application if sufficient resources exist.

In another exemplary embodiment of the computer readable medium above, the operations include receiving a denial for the change in operational states if sufficient resources do not exist.

In a further exemplary embodiment of any one of the computer readable medium above, the request further includes an indication of a priority of the radio application.

In another exemplary embodiment of any one of the computer readable medium above, the operations include receiving instructions to change operational states.

In a further exemplary embodiment of any one of the computer readable medium above, an operational state corresponds to a set of maximum allowed resource usage.

In another exemplary embodiment of any one of the computer readable medium above, the operational state further includes an identification of one or more of memory resource requirements and processor resource requirements.

A further exemplary embodiment in accordance with this invention is a method for providing a division of SDR RA into operational states. The method includes in a device including a plurality of shared device resources and a plurality of RAs, receiving, from a first RA, a request to change a state of the first RA to a requested active state. The requested active state is one of a plurality of potential active states for the first RA and each potential active state has an associated set of device resource requirements. The method also includes determining whether sufficient device resources exist for the requested active state based at least in part on currently allocated device resources. In response to a determination that sufficient device resources exist, the change to the requested active state for the first RA is approved.

In another exemplary embodiment of the method above, the method includes allocating device resources to the first RA based at least in part on the requested active state.

In a further exemplary embodiment of any one of the methods above, the method includes, in response to a determination that sufficient device resources do not exist for the requested active state, denying the change in state for the first RA.

In another exemplary embodiment of any one of the methods above, the request also includes an indication of a priority of the RA, and determining whether sufficient device resources exist is also based on a priority of each RA using the device resources.

In a further exemplary embodiment of any one of the methods above, the method includes, in response to a determination that sufficient device resources do not exist: determining whether a priority of a second RA using the device resources is lower than a priority of the first RA; and in response to a determination that the priority of the second RA is lower than the priority of the first RA, changing a state for the second RA, and approving the change in state for the first RA.

In another exemplary embodiment of any one of the methods above, the plurality of shared device resources includes radio resources (e.g., access to a radio transmitter, radio receiver, antenna, filter, power amplifier, low-noise amplifier, upconverter, downconverter, analog baseband, digital-to-analog converter, analog-to-digital converter, frequency synthesizer, digital front end). The plurality of shared device resources may also include CPU cycles, communication bus bandwidth, memory, hardware accelerator bandwidth, memory.

In a further exemplary embodiment of any one of the methods above, the device resource requirements include requirements for: timing parameters, a transmitter power, a channel bandwidth, a carrier frequency, a crest factor, processor type, hardware accelerator type, CPU cycles, communication bus bandwidth, hardware accelerator bandwidth and/or memory.

Another exemplary embodiment in accordance with this invention is an apparatus for providing a division of SDR radio application into operational states. The apparatus includes one or more processor and one or more memory which includes computer program code. The one or more memory and the computer program code configured to, with the one or more processor, cause the apparatus to perform operations. The operations include to receive, from a first RA, a request to change a state of the first RA to a requested active state, where the requested active state is one of a plurality of potential active states for the first RA and where each potential active state has an associated set of device resource requirements; to determine whether sufficient device resources exist for the requested active state based at least in part on currently allocated device resources; and in response to a determination that sufficient device resources exist, to approve the change to the requested active state for the first RA.

In a further exemplary embodiment of the apparatus above, the operations also include to allocate device resources to the first RA based at least in part on the requested active state.

In another exemplary embodiment of any one of the apparatus above, the operations also include, in response to a determination that sufficient device resources do not exist for the requested active state, to deny the change in state for the first RA.

In a further exemplary embodiment of any one of the apparatus above, the request also includes an indication of a priority of the RA, and where determining whether sufficient device resources exist is also based on a priority of each RA using the device resources.

In another exemplary embodiment of any one of the apparatus above, the operations also include: in response to a determination that sufficient device resources do not exist, to determine whether a priority of a second RA using the device resources is lower than a priority of the first RA; and in response to a determination that the priority of the second RA is lower than the priority of the first RA, to change a state for the second RA, and approve the change in state for the first RA.

In a further exemplary embodiment of any one of the apparatus above, the plurality of shared device resources includes radio resources (e.g., access to a radio transmitter, radio receiver, antenna, filter, power amplifier, low-noise amplifier, upconverter, downconverter, analog baseband, digital-to-analog converter, analog-to-digital converter, frequency synthesizer, digital front end). The plurality of shared device resources may also include CPU cycles, communication bus bandwidth, memory, hardware accelerator bandwidth, memory.

In another exemplary embodiment of any one of the apparatus above, the device resource requirements include requirements for at least one of: timing parameters, a transmitter power, a channel bandwidth, a carrier frequency, a crest factor, processor type, hardware accelerator type, CPU cycles, communication bus bandwidth, hardware accelerator bandwidth and/or memory.

A further exemplary embodiment in accordance with this invention is a computer readable medium tangibly encoding a computer program comprising program instructions, execution of the program instructions resulting in operations for providing a division of SDR radio application into operational states. The operations include, in a device including a plurality of shared device resources and a plurality of RAs, receiving, from a first RA, a request to change a state of the first RA to a requested active state. The requested active state is one of a plurality of potential active states for the first RA and each potential active state has an associated set of device resource requirements. The operations also include determining whether sufficient device resources exist for the requested active state based at least in part on currently allocated device resources. In response to a determination that sufficient device resources exist, the change to the requested active state for the first RA is approved.

In another exemplary embodiment of the computer readable medium above, the operations also include allocating device resources to the first RA based at least in part on the requested active state.

In a further exemplary embodiment of any one of the computer readable media above, the operations also include, in response to a determination that sufficient device resources do not exist for the requested active state, denying the change in state for the first RA.

In another exemplary embodiment of any one of the computer readable media above, the request also includes an indication of a priority of the RA, and determining whether sufficient device resources exist is also based on a priority of each RA using the device resources.

In a further exemplary embodiment of any one of the computer readable media above, the operations also include, in response to a determination that sufficient device resources do not exist: determining whether a priority of a second RA using the device resources is lower than a priority of the first RA; and in response to a determination that the priority of the second RA is lower than the priority of the first RA, changing a state for the second RA, and approving the change in state for the first RA.

In another exemplary embodiment of any one of the computer readable media above, the plurality of shared device resources includes radio resources (e.g., access to a radio transmitter, radio receiver, antenna, filter, power amplifier, low-noise amplifier, upconverter, downconverter, analog baseband, digital-to-analog converter, analog-to-digital converter, frequency synthesizer, digital front end). The plurality of shared device resources may also include CPU cycles, communication bus bandwidth, memory, hardware accelerator bandwidth, memory.

In a further exemplary embodiment of any one of the computer readable media above, the device resource requirements include requirements for at least one of: timing parameters, a transmitter power, a channel bandwidth, a carrier frequency, a crest factor, processor type, hardware accelerator type, CPU cycles, communication bus bandwidth, hardware accelerator bandwidth and/or memory.

Another exemplary embodiment in accordance with this invention is an apparatus for providing a division of SDR radio application into operational states. The apparatus includes a plurality of shared device resources; a plurality of RAs; means for receiving, from a first RA, a request to change a state of the first RA to a requested active state, where the requested active state is one of a plurality of potential active states for the first RA and where each potential active state has an associated set of device resource requirements; means for determining whether sufficient device resources exist for the requested active state based at least in part on currently allocated device resources; and means for, in response to a determination that sufficient device resources exist, approving the change to the requested active state for the first RA.

In a further exemplary embodiment of the apparatus above, the apparatus also includes means for allocating device resources to the first RA based at least in part on the requested active state.

In another exemplary embodiment of any one of the apparatus above, the apparatus also includes means for, in response to a determination that sufficient device resources do not exist for the requested active state, denying the change in state for the first RA.

In a further exemplary embodiment of any one of the apparatus above, the request also includes an indication of a priority of the RA, and where determining whether sufficient device resources exist is also based on a priority of each RA using the device resources.

In another exemplary embodiment of any one of the apparatus above, the apparatus also includes: means for, in response to a determination that sufficient device resources do not exist, determining whether a priority of a second RA using the device resources is lower than a priority of the first RA; and means for, in response to a determination that the priority of the second RA is lower than the priority of the first RA, changing a state for the second RA, and approving the change in state for the first RA.

In a further exemplary embodiment of any one of the apparatus above, the plurality of shared device resources includes radio resources (e.g., access to a radio transmitter, radio receiver, antenna, filter, power amplifier, low-noise amplifier, upconverter, downconverter, analog baseband, digital-to-analog converter, analog-to-digital converter, frequency synthesizer, digital front end). The plurality of shared device resources may also include CPU cycles, communication bus bandwidth, memory, hardware accelerator bandwidth, memory.

In another exemplary embodiment of any one of the apparatus above, the device resource requirements include requirements for at least one of: timing parameters, a transmitter power, a channel bandwidth, a carrier frequency, a crest factor, processor type, hardware accelerator type, CPU cycles, communication bus bandwidth, hardware accelerator bandwidth and/or memory.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., UE, etc.) are not intended to be limiting in any respect, as these parameters may be identified by any suitable names. Further, the formulas and expressions that use these various parameters may differ from those expressly disclosed herein.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
in a device comprising a plurality of shared device resources and a plurality of radio applications, receiving, from a first radio application, a request to change a state of the first radio application to a requested active state,
where the requested active state is one of a plurality of potential active states for the first radio application and
where each potential active state has an associated set of device resource requirements;
determining whether sufficient device resources exist for the requested active state based at least in part on currently allocated device resources; and
in response to a determination that sufficient device resources exist, approving the change to the requested active state for the first radio application.

2. The method of claim 1, further comprising allocating device resources to the first radio application based at least in part on the requested active state.

3. The method of claim 1, further comprising, in response to a determination that sufficient device resources do not exist for the requested active state, denying the change in state for the first radio application.

4. The method of claim 1, where the request further comprises an indication of a priority of the radio application, and where determining whether sufficient device resources exist is further based on a priority of each radio application using the device resources.

5. The method of claim 1, further comprising, in response to a determination that sufficient device resources do not exist:
determining whether a priority of a second radio application using the device resources is lower than a priority of the first radio application; and
in response to a determination that the priority of the second radio application is lower than the priority of the first radio application, changing a state for the second radio application, and approving the change in state for the first radio application.

6. The method of claim 1, where the plurality of shared device resources comprises radio resources.

7. The method of claim 1, where the device resource requirements comprise requirements for at least one of timing parameters, a transmitter power, a channel bandwidth, a carrier frequency, a crest factor, processor type, hardware accelerator type, CPU cycles, communication bus bandwidth, hardware accelerator bandwidth and memory.

8. An apparatus, comprising: a plurality of shared device resources; a plurality of radio applications at least one processor; and at least one memory including computer program code, the at least one memory and the computer program code configured to, with the at least one processor, cause the apparatus to perform at least the following:
receive, from a first radio application, a request to change a state of the first radio application to a requested active state, where the requested active state is one of a plurality of potential active states for the first radio application and where each potential active state has an associated set of device resource requirements;
determine whether sufficient device resources exist for the requested active state based at least in part on currently allocated device resources; and
in response to a determination that sufficient device resources exist, approve the change to the requested active state for the first radio application.

9. The apparatus of claim 8, further comprising allocating device resources to the first radio application based at least in part on the requested active state.

10. The apparatus of claim 8, where the at least one memory and the computer program code are further configured to, with the at least one processor, cause the apparatus to perform, in response to a determination that sufficient device resources do not exist for the requested active state, deny the change in state for the first radio application.

11. The apparatus of claim 8, where the request further comprises an indication of a priority of the radio application, and where determining whether sufficient device resources exist is further based on a priority of each radio application using the device resources.

12. The apparatus of claim 8, where the at least one memory and the computer program code are further configured to, with the at least one processor, cause the apparatus to perform:
in response to a determination that sufficient device resources do not exist, determine whether a priority of a second radio application using the device resources is lower than a priority of the first radio application; and
in response to a determination that the priority of the second radio application is lower than the priority of the first radio application, change a state for the second radio application, and approve the change in state for the first radio application.

13. The apparatus of claim 8, where the plurality of shared device resources comprises radio resources.

14. The apparatus of claim 8, where the device resource requirements comprise requirements for at least one of timing parameters, a transmitter power, a channel bandwidth, a carrier frequency, a crest factor, processor type, hardware accelerator type, CPU cycles, communication bus bandwidth, hardware accelerator bandwidth and memory.

15. A computer readable medium tangibly encoded with a computer program executable by a processor to perform actions comprising:
in a device comprising a plurality of shared device resources and a plurality of radio applications, receiving, from a first radio application, a request to change a state of the first radio application to a requested active state,
where the requested active state is one of a plurality of potential active states for the first radio application and
where each potential active state has an associated set of device resource requirements;
determining whether sufficient device resources exist for the requested active state based at least in part on currently allocated device resources; and
in response to a determination that sufficient device resources exist, approving the change to the requested active state for the first radio application.

16. The computer readable memory of claim 15, where the actions further comprise allocating device resources to the first radio application based at least in part on the requested active state.

17. The computer readable memory of claim 15, where the actions further comprise, in response to a determination that sufficient device resources do not exist for the requested active state, denying the change in state for the first radio application.

18. The computer readable memory of claim 15, where the request further comprises an indication of a priority of the radio application, and where determining whether sufficient device resources exist is further based on a priority of each radio application using the device resources.

19. The computer readable memory of claim 15, where the actions further comprise, in response to a determination that sufficient device resources do not exist:
determining whether a priority of a second radio application using the device resources is lower than a priority of the first radio application; and
in response to a determination that the priority of the second radio application is lower than the priority of the first radio application, changing a state for the second radio application, and approving the change in state for the first radio application.

20. The computer readable memory of any one of claims 15, where the device resource requirements comprise requirements for at least one of: timing parameters, a transmitter power, a channel bandwidth, a carrier frequency, a crest factor, processor type, hardware accelerator type, CPU cycles, communication bus bandwidth, hardware accelerator bandwidth and memory.
